(19) United States
(12) Patent Application Publication
(10) Pub. No.: US 2024/0392126 A1
(43) Pub. Date: Nov. 28, 2024

(54) WATER-BASED RESIN COMPOSITION FOR PAINT, AND PAINT

(71) Applicant: SOMAR CORPORATION, Chuo-ku, Tokyo (JP)

(72) Inventor: Naoki Sakazume, Chuo-ku, Tokyo (JP)

(21) Appl. No.: 18/694,461

(22) PCT Filed: Sep. 16, 2022
(86) PCT No.: PCT/JP2022/034667

§ 371 Date: Mar. 22, 2024

(30) Foreign Application Priority Data
Sep. 29, 2021 (JP) 2021-159584

(51) Int. Cl. C08L 67/00; C08K 3/04; C09D 5/02; C09D 7/20; C09D 7/61; C09D 167/00

(52) U.S. Cl. CPC C08L 67/00; C08K 3/04; C09D 5/028; C09D 7/20; C09D 7/61; C09D 167/00

(57) ABSTRACT

A water-based resin composition, which enables formation of a membrane with high designability, is provided. Here, (A) indicates a resin component, (A1) an acrylic resin emulsion, (A2) polyester-based resin emulsion, and (B) a black material, which is a composite of (B1) a black pigment having a particle diameter of 2 μm or more and 6 μm or less and a resin. A composition according to the present invention comprises at least (A) and (B): wherein (A) comprises 90% by mass or more of (A1) and (A2), and a mass ratio of a resin solid content of (A2) with respect to a resin solid content of (A1):1 is 1.8 or more and 4.4 or less; (B) comprises 90% by mass or more of (B1); and a mass ratio of (B) with respect to a resin solid content of (A):1 is 1.3 or more and 4.0 or less.

### TECHNICAL FIELD

The present invention relates to a water-based resin composition for paint, and a paint comprising the same.

### BACKGROUND ART

In electronic devices, such as a smartphone, tablet and personal computer, a black membrane is sometimes provided to a part or all of its chasses (regardless of an outer surface or inner surface) and a part of a not-viewed surface (e.g. a frame part) of a cover glass to be arranged and fixed to a viewing-surface side of a touch panel for the purpose of enhancing designability thereof, hiding its internal wiring, etc. and blocking lights, etc. In recent years, such demand is also found in a part (e.g. an outer frame of a lens) or all of electronic device components, such as a lens mounted on a variety of camera units, a model for building, such as a plastic model, or parts for building a model in a model building kit.

The patent document 1, for example, discloses a technique of forming a membrane on a chassis of a portable electronic device, such as a smartphone, by screen printing of an insulation material directly thereon or by in-mold molding to obtain a membrane-forming film having screen printing thereon.

### RELATED ART DOCUMENTS

### Patent Document

Patent Document 1: Japanese Patent Unexamined Patent Publication (Kokai) No. 2007-285093

### SUMMARY OF THE DISCLOSED SUBJECT MATTER

However, along with demands on enhancing designability in industrial products, there are more demands for providing a black membrane with higher designability (e.g. an uneven membrane) to those products.

The present invention was made in consideration with the circumstances above. The present invention has an object thereof to provide a water-based resin composition for paint and the paint capable of forming a membrane with high designability.

The present inventors conducted studies diligently and found that fulfilling the requirements below is effective to form a membrane with high designability, which realizes more than ever super low reflectance (less than 1.5%) and a super low L value (less than 15) in addition to low glossiness (less than 1.0%).
To use a resin composition having a specific composition comprising, in a predetermined ratio (in a range in a mass ratio), a resin component including a plurality of mixtures of water dispersion resins, which are incompatible with one another, and a black material including a specific composite having a particle diameter in a predetermined range.
To use, as an example of a plurality of mixtures to be included in the resin composition, those including an acrylic resin emulsion and polyester-based resin emulsion in a mass ratio in a predetermined range.

Based on these newly acquired knowledge, the present inventors completed the invention as provided below and attained the object above.

Below, (A) indicates a resin component, (A1) an acrylic resin emulsion, (A2) a polyester-based resin emulsion, (A3) a water-soluble polymer, (B) a black material, (B1) a composite of a black pigment ad a resin, and (C) a diluent solvent.

According to the present invention, there is provided a water-based resin composition for a paint, comprising at least (A) and (B): wherein
(A) comprises a water dispersion resin mixture obtained by combining a plurality of water dispersion resins incompatible to one another;
(B) comprises 90% by mass or more of (B1) having a particle diameter of 2 μm or more and 6 μm or less, and a mass ratio of (B) with respect to a resin solid content of (A): 1 is 1.3 or more and 4.0 or less.

The composition above may include the following modes.
Preferably, (A) comprises (A1) and (A2) in an amount of 90% by mass, and a resin solid content of (A2) with respect to a resin solid content of (A1): 1 is 1.8 or more and 4.4 or less;
Preferably, (B1) comprises an acrylic resin particle containing carbon black.
(A) may furthermore comprise (A3) and, in that case, a mass ratio of (A3) with respect to a resin solid content of (A1): 1 may be 1.2 or more and 1.7 or less.

According to the present invention, there is provided a paint comprising a composition above and (C), wherein viscosity at 25° C. measured by a B-type viscometer is 1 mPa·s or more and 300 mPa·s or less.

The paint above may include the following modes.
It may be used for applying to model parts.
It may be used for applying to camera parts.
It may be used for applying in the spray coating method.
It may be used for applying in the method using a pen-type application tool.
It may be used for applying by a method of painting with a brush.
It may be used for applying in the dip coating method.
It may be used for applying in the dispenser method.

According to the present invention, there is provided a pen-type application tool filled therein with the paint above.

According to the invention, there is provided a membrane formed from the paint above, wherein an outermost surface of a plane formed with the membrane has glossiness of less than 1.0% against an incident light at an angle of 60° (hereinafter, also simply referred to as “glossiness”), reflectance of less than 1.5% against a light having a wavelength of 550 nm (hereinafter, also simply referred to as “reflectance”), and an L value of less than 15 in the CIELAB color space system by the SCE method.

The membrane above may include the following modes.
An outermost surface of a plane formed with a membrane may have an optical density of 2.0 or more in the case where a light-shielding characteristic when transmitting a light is required to the membrane.

According to the present invention, there is provided a water-based resin composition for paint which enables formation of a membrane having high designability.

### Exemplary Mode for Carrying Out the Disclosed Subject Matter

Below, the best modes for carrying out the invention will be explained, however, the present invention is not limited to the modes below and also includes those obtained by suitably modifying or improving the modes explained below based on ordinary knowledge of persons skilled in the art within the scope of the present invention.

As to a range of value in the present specification, an uppermost value or a lowermost value described in certain value ranges may be replaced by values indicated in the examples.

In the present specification, when there are a plurality of kinds of substances falling under each component in a composition, a content ratio or a content in each component in the composition indicates a content ratio or a content of a total of the plurality of kinds of substances being in the composition unless otherwise mentioned.

### <Water-Based Resin Composition for Paint>

A water-based resin composition for paint according to one mode of the present invention (hereinafter, also simply referred to as “a composition”) comprises (A) a resin component and (B) a black material. (A) comprises a water dispersion resin mixture obtained by combining a plurality of water dispersion resins incompatible with one another (hereinafter, also simply referred to as “an emulsion particle”).

A membrane formed form a composition comprising (A) and (B) has low glossiness (less than 1.0%) comparing with a membrane formed from a water-based resin composition for a paint in the related art and, in addition, it realizes super low reflectance (less than 1.5%) and super low L value (less than 15) than before. The reason why is not very clear but, when comprising a water dispersion resin mixture in (A), an incompatible region is formed in a membrane after formation, as a result, the membrane after forming particles becomes an incompatible membrane. It is considered that a reaction between the incompatible membrane and (B) blended in the membrane contributes effectively to the expression of low glossiness, super low reflectance and super low L value.

### -(A)-

(A) to be used for forming a composition is a fixing material to a coating surface and is a binder for (B). Specifically, it includes a water dispersion resin mixture obtained by combining a plurality (two or more kinds) of water dispersion resins (emulsion particles) incompatible to one another. For example, in the case where the number of water dispersion resins to be combined is 2, when assuming that one water dispersion resin is resin A and another water dispersion resin is resin B, a resin having low compatibility with the resin A is used as the resin B.

In this case, the resin B has to be the one, with which a haze value of a formed membrane formed from a mixture with resin A increases along with its mixed amount. Specifically, a resin B, with which a haze value of a formed membrane (a thickness of 12 μm) formed from a mixture obtained by mixing the resin B and resin A in a mass ratio of 1:1 becomes 3.5% or more (preferably 4.5% or more), may be defined as a resin, which is not compatible with the resin A (namely, a resin which is incompatible with resin A). A haze value may be measured in the method explained later on.

Whether combined water dispersion resins formed a “not compatible region” (incompatible region) to one another or not in a formed membrane may be confirmed also by observing a sectional surface of the formed membrane with a microscope to see whether separate solid phases can be detected or not.

When containing a water dispersion resin mixture, an incompatible region can be formed in a formed membrane, consequently, a membrane after forming particles becomes incompatible. Blending of (B) into the incompatible membrane also works together to make the membrane surface low glossy. Moreover, super low reflectance than ever can be attained and a blackness degree can be enhanced furthermore (an L value becomes furthermore lower to be a super low L value). Those facts above had been found by the present inventors.

In one mode, as long as two kinds of water dispersion resins form an incompatible region in a formed membrane, the case where a part of one resin A is dissolved in the other resin B is within the scope of the present invention. When using three or more (4 kinds or more) water dispersion resins, the respective water dispersion resins may be all incompatible with one another and, alternatively, it is sufficient if one water dispersion resin is incompatible with a mixed resin composed of other two or more (three or more) water dispersion resins, which are incompatible to one another.

Combination of water dispersion resins are selected two or more kinds from, for example, an acrylic resin emulsion, polyester-based resin emulsion, urethane-based resin emulsion, polyvinyl acetate resin emulsion, polyvinyl chloride resin emulsion, polybutadiene-based resin emulsion and polyolefin-based resin emulsion, etc. Among them, in terms of attaining low glossiness, super low reflectance and a super low L value on a surface of a formed membrane and strength of the membrane, combination including the two kinds, which are an acrylic resin emulsion and a polyester-based resin emulsion, is preferable.

In one mode, a minimum temperature for forming a membrane of a water dispersion resin mixture is, in terms of forming a coating in a normal temperature and providing necessary stability on the coating surface, for example, less than 40° C. and it may be also less than 0° C.

Below, an explanation will be made on the case where the number of water dispersion resins to be combined is two (namely, a combination of resin A and resin B above) as an example, wherein an acrylic resin emulsion is referred to as (A1) and a polyester-based resin emulsion as (A2). Note that the combination of (A1) and (A2) is merely a preferable example (one mode). Accordingly, there is no intention of limiting the present invention to this mode.

### (A1)

As a result that (A1) is included in a water dispersion resin mixture to be contained in (A), a membrane having excellent water resistance and excellent adhesiveness to a coating surface can be formed. Moreover, a formed membrane obtains advantages, such as membrane strength and light resistance.

(A1) composing a part of (A) includes an acrylic resin and, furthermore, it is contained in a state of an emulsion in a composition of the present invention. Here, in a state of an emulsion indicates a state where a resin, etc. contained in resin emulsion are dispersed as fine particles in a composition. A resin in a state of an emulsion exhibits a property of increasing viscosity and coagulating when an aqueous solvent, which is generally as a continuous phase, decreases due to evaporation or permeation, etc. so as to be able to enhance adhesiveness to a coating surface.

As an acrylic resin in (A1), for example, a polymer, etc. obtained by polymerizing one or more kinds of radical polymeric monomers may be mentioned. (A1) may be obtained by preparing aqueous emulsion by polymerizing one or more kinds of monomer(s) selected, for example, from a functional group-containing monomer of adduct, etc. of (meth)acrylic acid, hydroxyethyl(meth)acrylate, hydroxypropyl(meth)acrylate, hydroxybutyl(meth)acrylate, hydroxyethyl (meth)acrylate with ε-caprolactone, furthermore, as alkylester (meth)acrylate, methyl (meth)acrylate, ethyl(meth)acrylate, propyl(meth)acrylate, butyl(meth)acrylate, hexyl(meth)acrylate, 2-ethylhexyl(meth)acrylate, octyl(meth)acrylate, nonyl(meth)acrylate, decyl(meth)acrylate, dodecyl(meth)acrylate, stearyl(meth)acrylate, isobornyl(meth)acrylate, and lauryl(meth)acrylate.

As aqueous emulsification, a method of polymerizing a solvent and, then, emulsifying by forced stirring in water or by using an emulsifier, etc. and an emulsion polymerization method of copolymerizing by using an emulsifier in water, etc. may be mentioned.

In one mode, (A1) includes an acrylic resin containing at least one of a hydroxy group and carboxyl group and includes, for example, an acrylic resin containing a hydroxy group and carboxyl group.

In one mode, an acrylic resin in (A1) is a crosslinking resin particle and has, for example, crosslinkability and, furthermore, it may be an acrylic resin particle containing at least one of a hydroxy group and carboxyl group.

In one mode, an acrylic resin containing a hydroxy group and carboxyl group may be obtained by emulsifying and polymerizing a monomer mixture containing alkyl(meth)acrylate (i), a carboxyl group-containing ethylenically unsaturated monomer (ii) and a hydroxy group-containing ethylenically unsaturated monomer (iii). Note that compounds exemplified below as components of a monomer mixture may be used in combination of one or more kinds. Note that “(meth)acryl” indicates both of acryl and methacryl.

Alkyl(meth)acrylate (i) is used for configuring the main frame of (A1).

As specific examples of alkyl(meth)acrylate (i), those mentioned above as alky (meth)acrylate may be mentioned.

A carboxyl group-containing ethilenically unsaturated monomer (ii) may be used to improve storage stability of (A1) to be obtained and other stabilities, such as mechanical stability.

As carboxyl group-containing ethilenically unsaturated monomer (ii), for example, acrylic acid, methacrylic acid, crotonic acid, isocrotonic acid, ethacrylic acid, propyl acrylate, isopropyl acrylate, itaconic acid, maleic anhydride and fumaric acid, etc. may be mentioned.

A hydroxy group-containing ethylenically unsaturated monomer (iii) may be used for providing (A1) with hydrophilicity based on a hydroxy group and to improve workability, etc. when using (A1) as a paint.

As a hydroxy group-containing ethylenically unsaturated monomer (iii), for example, 2-hydroxyethyl(meth)acrylate, 2-hydroxypropyl(meth)acrylate, 4-hydroxybutyl(meth)acrylate, N-methylol acrylamide, allyl alcohol, ¿-caprolactone-modified (meth)acryl monomer, etc. may be mentioned.

As specific examples of ε-caprolactone-modified acrylic monomer, “Placcel FA-1”, “Placcel FA-2”, “Placcel FA-3”, “Placcel FA-4”, “Placcel FA-5”, “Placcel FM-1”, “Placcel FM-2”, “Placcel FM-3”, “Placcel FM-4” and “Placcel FM-5”, etc. produced by Daicel Corporation may be mentioned.

A monomer mixture may contain, as an optional component, at least one kind of monomer selected from a group of a styrene-based monomer, nitryl (meth)acrylate and (meth)acrylamide. As a styrene-based monomer, α-methylstyrene, etc. may be mentioned besides styrene. Also, as a crosslinking monomer, ethylene glycol di(meth)acrylate and divinyl benzene, etc. may be mentioned.

Emulsion polymerization may be carried out by heating the monomer mixture mentioned above while agitating in an aqueous solution in a presence of a radical polymerization initiator and emulsifier. A reaction temperature thereof is, for example, 30 to 100° C. or so, preferable reaction time is, for example, 1 to 10 hours or so, and the reaction temperature may be adjusted by adding the monomer mixture or monomer pre-emulsifying liquid at a time or by dripping gradually to a reaction container filled with water and an emulsifier.

As a radical polymerization initiator, well-known initiator normally used in emulsion polymerization of acrylic resins may be used. Specifically, as a water-soluble free radical polymerization initiator, for example, potassium persulfate, sodium persulfate, ammonium persulfate or other persulfates may be used in a form of a solution. Also, a so-called redox-based initiators obtained by combining an oxidant, such as potassium persulfate, sodium persulfate, ammonium persulfate and hydrogen peroxide, with a reducing agent, such as sodium bisulfite, sodium thiosulfate, rongalite and ascorbic acid, may be used in a form of a solution.

As an emulsifier, an anionic or ionic (nonionic) emulsifier selected from micelle compounds, wherein one molecular includes a hydrocarbon group having 6C or more carbon atoms and a hydrophilic moiety of carboxylate, sulfonate, sulfate partial ester, etc. may be used. Among them, as an anionic emulsifier, alkali metal salt or ammonium salt of sulfuric acid semiester of alkylphenols or higher alcohols; alkali metal salt or ammonium salt of alkyl or allylsulfonate; and alkali metal salt or ammonium salt of sulfuric acid semiester of polyoxyethylene alkylphenyl ether, polyoxyethylene alkylether or polyoxyethylene allylether, etc. may be mentioned. As a nonionic emulsifier, polyoxyethylene alkylpheny ether, polyoxyethylene alkyl ether or polyoxyethylene allyl ether, etc. may be mentioned. Also, other than those generally-used anionic and nonionic emulsifiers, a variety of anionic and nonionic reactive emulsifiers, etc. having radically polymerizable unsaturated double-bond in its molecular, namely, those having an acrylic, methacrylic, propenylic, allylic, allylether-based or maleic acid-based group, etc., may be used alone or in combination of two or more kinds.

When performing emulsion polymerization, use of an auxiliary agent for molecular weight modification (chain transfer agent), such as a mercaptan compound and lower alcohol, etc. together is preferable in many cases in terms of accelerating emulsion polymerization and in terms of enhancing formation of a smooth and uniform membrane so as to improve adhesiveness to an object to be coated, so that it is used properly in accordance with the condition.

In emulsion polymerization, any of the polymerization methods may be used, such as a normal single-stage continuous monomer uniform dropping method, a core shell polymerization method as a multi-stage monomer field method, and a power feed polymerization method for continuously changing a monomer composition to be fed during polymerization, etc.

Also, to maintain stability of (A1) by neutralizing a part or all of carbonic acid, a basic compound may be added to an obtained (A1). As the basic compound, ammonia, a variety of amines and alkali metals, etc. may be used accordingly.

A molecular weight of an acrylic resin in (A1) is not particular limited and may be, for example, 50,000 or more and 1,000,000 or less and may be 100,000 or more and 800,000 or less in weight-average molecular weight (Mw).

A glass transition temperature (Tg) of an acrylic resin in (A1) may be, for example, −10° C. or more and 100° C. or less, and 0° C. or more and 80° C. or less. A glass transition temperature (Tg) of an acrylic resin may be 10° C. or more and 80° C. or less. When a glass transition temperature (Tg) is in ranges as above, the acrylic resin can be dispersed in a membrane to exhibit a high opacifying property.

An acid number of an acrylic resin in (A1) may be, for example, 2 mgKOH/g or more and 20 mgKOH/g or less and may be 5 mgKOH/g or more and 10 mgKOH/g or less. When an acid number is in such ranges, it is possible to obtain an advantage of improving compatibility with a solvent. Note that an acid number is defined as a weight (mg) of potassium hydroxide (KOH) required to neutralize acid components in 1 g of a sample (solid content of the resin) (it will be the same below). Such an acid number can be adjusted by a kind and content, etc. of a monomer constituting the resin. The acid number as above can be adjusted by a content, etc. of a structural unit of (meth)acrylate or other acid group-containing monomer derivative in an acrylic resin.

A hydroxyl number in an acrylic resin in (A1) may be, for example, 5 mgKOH/g or more and 20 mgKOH/g or less and may be 10 mgKOH/g or more and 20 mgKOH/g or less. When a hydroxyl number is in the ranges as above, it is possible to obtain an advantage of dispersibility and self-crosslinkability.

Note that a hydroxyl number is defined as mass (mg) of KOH required to acetylate a hydroxyl group in 1 g of a sample (a solid content of the resin) (it will be the same below).

A particle diameter of an acrylic resin in (A1) may be, for example, 100 nm or more and 900 nm or less and may be 200 nm or more and 500 nm or less.

A medium, wherein an acrylic resin is dispersed, (dispersion medium) in (A1) is water or a mixed solvent of water and water-soluble organic solvent. The water-soluble organic solvent is not particularly limited as long as it can be mixed with water and, for example, mono alcohols, polyhydric alcohols, lower alkyl ethers of polyhydric alcohol, ketones, ethers, esters and nitrogen-containing compounds, etc. may be mentioned. They may be used alone or in combination of two or more kinds.

As mono alcohols, methanol, ethanol, n-propanol, n-butanol, isobutanol, n-pentanol, n-hexanol, n-heptanol, n-octanol, n-nonyl alcohol, n-decanol or isomers thereof, cyclopentanol and cyclohexanol, etc. may be mentioned, and preferably alcohols having a 1C to 6C alkyl group may be used.

As polyhydric alcohols, ethylene glycol, propyrene glycol, 1,3-butylene glycol, 1,4-butylene glycol, 1,2-pentandiol, 1,5-pentandiol, neopentyl glycol, 1,2-hexandiol, 1,6-hexandiol, 1,2-cyclohexanediol, heptandiol, 1,8-octanediol, 1,9-nonandiol, 1,10-decanediol, glycerin, pentaerythritol, diethylene glycol, dipropylene glycol, triethylene glycol, tetraethylene glycol, polyethylene glycol, polypropylene glycol and thiodiglycol, etc. may be used.

As lower alkyl ethers of polyhydric alcohol, ethylene glycol monomethyl ether, ethylene glycol dimethyl ether, ethylene glycol monoethyl ether, ethylene glycol diethyl ether, ethylene glycol mon propyl ether, ethylene glycol isopropyl ether, ethylene glycol monobutyl ether, ethylene glycol isobutyl ether, propylene glycol monomethyl ether, propyrene glycol monoethyl ether, propylene glycol-n-propyl ether, propylene glycol monobutyl ether, diethylene glycol monomethyl ether, diethylene glycol monoethyl ether, dipropylene glycol mono-n-propyl ether and dipropylene glycol mono-n-butylether, etc. may be used.

A content of a water-soluble organic solvent is preferably as little as possible and it is not necessarily blended. A content of blending is preferably 0 to 10.0% by mass and more preferably 0 to 5.0% by mass in 100% by mass of a mixed solvent. When exceeding 10.0% by mass, incomplete drying arises and blocking resistance declines.

Resin solid content concentration (also simply referred to as “a solid content ratio”) of (A1) may be, for example, 10% by mass or more. Preferably, 15% by mass or more, more preferably 25% by mass or more, preferably 50% by mass or less and more preferably 35% by mass or less.

A pH value of (A1) may be, for example, 4 or more and 8 or less and may be 4 or more and 7 or less. When a pH value is within such ranges, adhesiveness of a membrane to be formed to an object to be coated can be improved furthermore.

As (A1), a market-available products can be used. For example, EM57DOC (by Daicel Miraizu Ltd.), Mowinyl 7471, Mowinyl 7540, Mowinyl DM774, Mowinyl 6520 (by Mitsubishi Chemical Group): NeoCryl A-639, NeoCryl A-1127 (by Kusumoto Chemicals, Ltd.), VINYBLAN 278, and VINYBLAN 690 (by Nissin Chemical co., ltd.): etc. may be mentioned.

They may be used alone or in combination of two or more kinds.

### (A2)

As a result of including (A2) in a water dispersion resin mixture included in (A), a formed membrane obtains an advantage of an improvement of membrane strength, etc.

(A2) constituting a part of (A) comprises a polyester-based resin, and is contained in a state of an emulsion in the composition of the present invention. This point is the same as in (A1).

As a polyester-based resin in (A2), for example, a condensate of polybasic acid and polyhydric alcohol, etc. may be mentioned. As a polybasic acid, for example, a phthalic anhydride, isophthalic acid, terephthalic acid, adipic acid, succinic anhydride, etc. may be mentioned. As polyhydric alcohol, for example, ethylene glycol, propylene glycol, 1,3-butylene glycol, 1,6-hexane diol, polyethylene glycol and polypropylene glycol, etc. may be mentioned.

In one mode, a polyester-based resin in (A2) preferably has a carboxy group and/or sulfonic acid group. As a result that a polyester-based resin has these hydrophilic groups, dispersibility in water becomes preferable and, consequently, more uniform membrane can be formed from a paint containing the composition and adhesiveness of the membrane to an object to be coated can be improved furthermore.

A molecular weight of a polyester resin in (A2) is not particularly limited and may be, for example, 6,000 or more and 20,000 or less and may be 8,500 or more and 20,000 or less in the number average molecular weight (Mn).

A glass transition temperature (Tg) of a polyester resin in (A2) may be, for example, 40° C. or more and 80° C. or less and may be 55° C. or more and 75° C. or less. When a glass transition temperature (Tg) is in the ranges above, it is possible to form a membrane having excellent water resistance and excellent adhesiveness to an object to be coated.

An acid number of a polyester-based resin in (A2) may be, for example, 1 mgKOH/g or more and 10 mgKOH/g, and may be 1 mgKOH/g or more and 8 mgKOH/g. When an acid number is within the ranges, it is possible to obtain an advantage of improving compatibility with a solvent.

A hydroxyl number of a polyester resin in (A2) may be, for example, 1 mgKOH/g or more and 20 mgKOH/g or less, and may be 1 mgKOH/g or more and 10 mgKOH/g or less. When a hydroxyl number is within the ranges above, it is possible to obtain an advantage of dispersibility and self-crosslinkability.

A particle diameter of a polyester-based resin in (A2) may be, for example, 10 nm or more and 300 nm or less and may be 50 nm or more and 150 nm or less.

As a dispersion medium of a polyester-based resin in (A2), water or a mixed liquid of water and an organic solvent may be used as in the same way as in the dispersion medium in (A1) explained above.

A solid content ratio in (A2) may be, for example, 50% by mass or more, preferably 60% by mass, more preferably 70% by mass and preferably 90% by mass or less and more preferably 80% by mass or less.

As (A2), market-available products can be used. For example, KA-5071S, KZT-8803, KT-8701, KZT-9204 (by UNITIKA Ltd.): VYLONAL MD1200, MD1245, MD1480, MD1930, MD2000 and MD1500 (by TOYOBO Co., Ltd.): PES-H001 and other High-Tech PE Series (by TOHO Chemical Industry Co., Ltd.): NEWTLAC 2010 (by Kao Corporation): SUPERFLEX 210 (by DKS Co., Ltd.): PLAS COAT Z730, Z760, Z592, Z687 and Z690 (by GOO Chemical Co., Ltd.): etc. may be mentioned.

They may be used alone or in combination of two or more kinds.

In one mode, a mass ratio of a resin solid content in (A2) in (A) is preferably 1.8 or more, more preferably 2.0 or more and preferably 4.4 or less and more preferably 3.0 or less with respect to a resin solid content in (A1): 1. By blending (A2) in these ranges of a mass ratio of resin solid content, it is possible to obtain stability of membrane strength (falling off of the membrane from a coating surface or an adhesiveness failure to a coating surface is not caused).

A total content (total amount) of (A1) and (A2) in (A) is preferably 90% by mass or more, more preferably 95% by mass or more. The upper limit thereof is not particularly limited and is 100 mas %. Namely, in one mode, (A1) and (A2) may be contained preferably 90% by mass or more in 100% by mass of (A).

When (A) contains other resin emulsion together with (A1) and (A2), a mass ratio of a resin solid content of this other resin emulsion in (A) is, for example, 0.4 or less with respect to a total of (A1) and (A2): 1.

Note that a molecular weight (Mw and Mn), glass transition temperature (Tg), acid number, hydroxyl number, particle diameter and a resin solid content concentration (solid content ratio) of emulsion of each water dispersion resin (an acrylic resin, polyester resin and other resins) may be measured by any methods known to persons skilled in the art.

For example, a molecular weight (Mw and Mn) of each water dispersible resin is measured by gel permeation chromatography (GPC). GPC is a molecular weight obtained by using HLC-8020GPC (by TOSOH Corporation), using as columns three of TSKgel and Super Multipore HZ-H (by TOSOH Corporation, 4.6 mm ID×15 cm), using THF (tetrahydrofuran) as an eluent to detect by a solvent THF, using polystyrene as a standard substance and converting.

A glass transition temperature (Tg) is measured by the DSC method using a differential scanning analyzing calorimeter. More specifically, a glass transition temperature may be measured by a differential scanning calorimeter (DSC) (for example, a differential scanning calorimeter “DSC-50” by Shimadzu Corporation). Note that when a plurality of glass transition temperatures are observed, a main transfer temperature with a larger endothermic quantity may be applied.

An acid number and hydroxyl number may be measured based on the method (potentiometric titration) defined in JIS (Japanese Industrial Standards) (JIS K0070, 1992).

A particle diameter is an average particle diameter of primary particle and may be measured, for example, by a dynamic light scattering method by using a particle size distribution analyzer (FPAR-1000 by Otsuka Electronics Co., Ltd.) or may be measured (specified), for example, by an image analysis using a transmission type electron microscope (TEM) or a scanning type electron microscope (SEM).

A solid content in an emulsion is calculated from a residual after drying at 150° C. for 2 hours.

### (A3)

(A) may comprise (A3) a water-soluble polymer together with a water dispersion resin mixture. When (A) comprises (A3), a formed membrane is expected to have improved adhesiveness to a coating surface.

A water-soluble polymer is not particularly limited as long as it is water-soluble. For example, polycarbonate-based polymer, polyvinyl alcohol-based polymer, cellulose and its derivatives, gelatine, a polymer having a constituent unit derived from N-vinyl cyclic lactam, etc. may be mentioned. They may be used alone or in combination of two or more kinds.

When making (A) contain (A3), in terms of stability of a composition, polyvinyl alcohol (PVA) is preferably used. Polyvinyl alcohol is a polymer compound obtained by saponifying polyvinyl acetate with alkali, acid or ammonia water, etc. and a partially-saponified type with a saponifying degree of 78.5 to 89.0 mol % is preferable because it is preferable for stability of the composition over time. This is so-called polyvinyl alcohol (PVA) with a low saponifying degree or a medium saponifying degree.

Also, an average polymerization degree is preferably 300 to 2300 or so and is furthermore preferably 1500 to 1900 or so.

As (A3), market-available products can be used. For example, Gohsenol GH23 (a polymerization degree of 2300 or so, saponification degree of 86.5 to 89.0 mol %), Gohsenol GH20 (a polymerization degree of 2000 or so, saponification degree of 86.5 to 89.0 mol %), Gohsenol GH17 (a polymerization degree of 1700 or so, saponification degree of 86.5 to 89.0 mol %), Gohsenol GH14 (a polymerization degree of 1400 or so, saponification degree of 86.5 to 89.0 mol %), Gohsenol GL-03 (a polymerization degree of 300 or so, saponification degree of 86.5 to 89.0 mol %), Gohsenol GL-05 (a polymerization degree of 500 or so, saponification degree of 86.5 to 89.0 mol %), Gohsenol KH20 (a polymerization degree of 2000 or so, saponification degree of 78.5 to 81.5 mol %), Gohsenol KH17 (a polymerization degree of 1700 or so, saponification degree of 78.5 to 81.5 mol %), Gohsenol KL-03 (a polymerization degree of 300 or so, saponification degree of 78.5 to 82.0 mol %) and Gohsenol KL-05 (a polymerization degree of 500 or so, saponification degree of 78.5 to 82.0 mol %) (all by Mitsubishi Chemical Corporation): Kuraray Poval PVA-203 (a polymerization degree of 300 or so, saponification degree of 86.5 to 89.5 mol %), Kuraray Poval PVA-204 (a polymerization degree of 400 or so, saponification degree of 86.5 to 89.5 mol %), Kuraray Poval PVA-205 (a polymerization degree of 500 or so, saponification degree of 86.5 to 89.5 mol %), Kuraray Poval PVA-210 (a polymerization degree of 1000 or so, saponification degree of 88.0 mol %), Kuraray Poval PVA-217 (a polymerization degree of 1700 or so, saponification degree of 88.0 mol %), Kuraray Poval PVA-220 (a polymerization degree of 2000 or so, saponification degree of 88.0 mol %), Kuraray Poval PVA-217EE (a polymerization degree of 1700 or so, saponification degree of 88.0 mol %), Kuraray Poval PVA-217E (a polymerization degree of 1700 or so, saponification degree of 88.0 mol %), Kuraray Poval PVA-220E (a polymerization degree of 2000 or so, saponification degree of 88.0 mol %), Kuraray Poval PVA-403 (a polymerization degree of 300 or so, saponification degree of 80.0 mol %), Kuraray Poval PVA-405 (a polymerization degree of 500 or so, saponification degree of 83.0 mol %), Kuraray Poval PVA-420 (a polymerization degree of 2000 or so, saponification degree of 81.0 mol %) (all by Kuraray Co., Ltd.): Denka Poval B-03 (a polymerization degree of 300 or so, saponification degree of 87 to 89 mol %), Denka Poval B-05 (a polymerization degree of 500 or so, saponification degree of 87 to 89 mol %) (both by Denka Company Limited); and UNITIKA POVAL UP050G (a polymerization degree of 500 or so, saponification degree of 87 to 89 mol % or so) (by Unitika Ltd.): etc. may be mentioned.

They may be used alone or in combination of two or more kinds.

When (A) comprises (A3), a mass ratio of (A3) in (A) is, with respect to a resin solid content in (A1): 1, preferably 1.2 or more, more preferably 1.35 or more and preferably 1.7 or less and more preferably 1.55 or less. When blending (A3) in the ranges of a resin solid content mass ratio as above, it becomes easy to improve adhesiveness of a formed membrane to a coating surface.

A content (total amount) of a resin solid content in (A) is not particularly limited but, when considering a blending balance with other components, it is preferably 10% by mass or more, more preferably 20% by mass or more, furthermore preferably 25% by mass or more, and preferably 50% by mass or less, more preferably 40% by mass or less and furthermore preferably 35% by mass or less with respect to a total amount (100% by mass) of a composition.

### -(B)-

(B) to be used for forming a composition comprises (B1) a composite of a black pigment and a resin.

As a resin constituting a composite with a black pigment, those having a water-soluble property are used. As such resins, for example, an epoxy resin, acrylic resin, urethane resin, styrene resin, ethylene resin, phenol resin, urea resin, amide resin, melamine resin and benzoguanamine resin, etc. may be mentioned. Among them, in terms of dispersibility, an acrylic resin and urethane resin are preferable and an acrylic resin is more preferable.

They may be used alone or in combination of two or more kinds.

Note that by combining a resin name before a word beads, a name of a resin particle may be partially omitted. For instance, a resin particle made of an acrylic resin may be called acrylic beads in some cases.

A black pigment constituting a composite with a resin is not particularly limited but carbon black (hereinafter, also simply referred to as “CB”) is preferably used because an effect of making the composite black is significant with it and it is advantageous in terms of the price. When using CB, a membrane to be formed is colored, so that the effect of preventing reflection improves furthermore and a preferable antistatic effect can be obtained, as well.

As a form of a composite of a black pigment and a resin, for example, any of (1) a form of covering the black pigment with a resin (including a form of containing a black pigment in a resin particle), (2) a form of bonding a resin with a surface or inside of the black pigment, and (3) a form that a resin is adhered to a surface or inside of the black pigment, or a form of combining those may be mentioned.

As a means of covering a surface of a black pigment with a resin, for example, a microcapsule method, more specifically, an interfacial polymerization method, in-situ polymerization method, in-liquid cured coating method (Orifice method), a phase separation method from a solution and in-liquid drying method, etc. may be mentioned. Moreover, other than the microcapsule methods, there are methods of bringing a resin bonded with a dispersed black pigment or bringing a resin adhered to a black pigment, as well. As an example thereof, there is a form that a pigment as a core is covered on its surface with a large number of colloidal resin particles. When applying a coloring agent obtained by covering a black pigment as a core with a large number of colloidal resin particles, it is desired that a size of the resin particle around the pigment core is sufficiently small. Furthermore, it is desired that the colloidal resin particle covers a pigment core with almost no gap left. However, it is not to exclude those that a pigment core is exposed directly to the outside.

Also, (B1) may be obtained by bonding a pigment with a resin in about the same size as the pigment particle. Alternately, by kneading a black pigment or black dye in a thermoplastic resin or thermosetting resin and pulverizing, the black pigment, etc. can be compounded with a resin.

In one mode, in terms of improving dispersibility, a compounding mode is preferably the mode (1), which is the mode of a resin particle containing a black pigment. Comparing with the case of mixing a pigment having a small diameter directly in a composition, a resin particle containing a black pigment therein contributes to an improvement of dispersibility because the pigment is contained in the resin particle having a larger diameter and an aggregate is hard to be caused in the composition.

A content of a pigment (CB in particular) in (B1) is preferably 1% by mas or more, more preferably 5% by mass or more, furthermore preferably 10% by mass or more, and preferably 50% by mass or less, more preferably 40% by mass or less and furthermore preferably 30% by mass or less.

A particle diameter of (B1) is preferably 2 μm or more, more preferably 3 μm or more, and preferably 8 μm or less, more preferably 6 μm or less, and furthermore preferably 4 μm or less. When a particle diameter is too small, aggregates increase in the composition, so that there is a tendency that dispersion becomes difficult. When a particle diameter is too large, the coloring effect tends to decline.

Note that a particle diameter of (B1) is a value of a particle diameter when an integrated value expressed by an integration (cumulation) percentage becomes 50% (D50) in a particle diameter distribution.

A shape of (B1) is not particularly limited but sphere is preferable in terms of a matting property. In order to realize lower glossiness, lower reflectance and a lower L value on a surface of a membrane to be formed, it is preferable to use particles having a narrow particle distribution (a CV (Coefficient of Variation) value is, for example, 15 or less) (a sharp product). The CV value is a numerically expressed degree of spread of a particle diameter distribution (variation of particle diameters) with respect to an average value of particle diameters (calculated average particle diameter). When using a particle as above, it is contained uniformly in a membrane and fine unevenness is formed on the membrane surface, so that furthermore lower glossiness, lower reflectance and a lower L value on the membrane surface can be realized easily.

Also, in order to reduce a glossiness degree furthermore on the membrane surface to be formed, a particle in an indefinite form may be used as (B1), as well. When using a particle in an indefinite form as (B1), lights refract repeatedly inside and surface of (B1) when formed into a membrane, consequently, a glossiness on the membrane surface can be furthermore reduced.

As (B1), market-available products can be used. As those including urethane beads, for example, Art Pearl C800 black (a particle diameter 6.5 μm, CB content 7.5%, by Negami Chemical Industrial Co., Ltd.): etc. may be mentioned. As those including acrylic (acrylic copolymer) beads, for example, Art Pearl GR-004BK (a particle diameter 3.8 μm, CB content 37%, by Negami Chemical Industrial Co., Ltd.): and RUBCOULEUR 224 (SMD) black (a particle diameter 2 to 3 μm, CB content 18%, by Dainichiseika Color & Chemicals Mfg. Co., Ltd.): etc. may be mentioned.

A content of (B1) in (B) is preferably 90% by mass or more and more preferably 95% by mass or more. An upper limit thereof is not particularly limited and is 100% by mass. Namely, in one mode, (B1) may be included preferably by 90% by mass or more in 100% by mass of (B).

In one mode, a mass ratio of (B) is preferably 1.3 or more, more preferably 1.9 or more, and preferably 4.0 or less and more preferably 3.0 or less with respect to a resin solid content in (A): 1. When blending (B) in these mass ratio ranges, it is possible to realize low glossiness, low reflectance and a low L value while maintaining strength of a coated membrane.

A content (total amount) of (B) is, with respect to a total amount (100% by mass) of all solid content of a composition, for example, 60% by mass or more, preferably 65% by mass or more, more preferably 75% by mass or more and, for example, 90% by mass or less, preferably 85% by mass or less and more preferably 80% by mass or less. When a total amount of (B) is less than 60% by mass, disadvantages of an increase of glossiness and a short of optical concentration arise, while when exceeds 90% by mass, an amount of (A) in a formed membrane decreases relatively, as a result, a disadvantage of falling off of a membrane from an object to be coated may occur in some cases.

### -Optional Components-

Other than the components ((A) and (B)) above, the composition may comprise other optional components as long as it does not hinder the effects of the present invention. However, a total mass of the components ((A) and (B)) is preferably 50% by mass or more in 100% by mass of a solid content of the composition. Although the mass ratio differs depending on properties required to the composition, more preferably 70% by mass or more, furthermore preferably 80% by mass or more and particularly preferably 90% by mass or more.

The composition is an aqueous composition, wherein the emulsions above (A1 and A2) are dispersed in the dispersion medium above.

A composition according to one mode of the present invention may be prepared (produced) by mixing and agitating (A1), (A2), (B) and optional components to be added in accordance with need. An order of mixing each component is not particularly limited as long as the components are mixed uniformly.

### <Aqueous Paint>

An aqueous paint according to one mode of the present invention (hereinafter also simply referred to as “a paint”) is used for forming a membrane made of a composition explained above on a coating surface and comprises the composition above and (C) a diluting solvent.

A content of the composition above in a paint is, with respect to a total amount (100% by mass) of a total solid content in the paint, preferably 90% by mass or more and more preferably 95% by mass or more. An upper limit thereof is not particularly limited and is 100% by mass.

### -(C)-

(C) to be used for forming a paint is blended for the purpose of adjusting viscosity of the paint. By using (C), uniformity of a paint is improved. Also, viscosity of the paint can be adjusted properly and it becomes possible to improve operability of the paint and uniformity of a coating thickness, consequently, it may largely contribute to enhance designability of a finally obtained product.

As (C), it is not particularly limited as long as it is a solvent capable of adjusting viscosity of a paint. Water or a mixed liquid of water and an organic solvent as same as a dispersion medium of emulsion particles explained above may be used. A blending amount thereof may be set accordingly in order to adjust a solid content concentration of a paint.

Viscosity of a paint cannot be defined generally because a proper range differs depending on an application method, however, viscosity at 25° C. by a B-type viscometer is 1 mPa·s or more and 300 mPa·s or less or so. For example, when using a spray coating method as an application method, it is preferably 1 mPa·s or more and 50 mPa·s or less or so. When using a dip coating method as an application method, it is preferably 100 mPa·s or more and 300 mPa·s or less or so. When using a dispenser method as an application method, it is preferably 100 mPa·s or more and 250 mPa·s or less or so. When using by filling a paint in a pen-type application tool, it is preferably 80 mPa·s or more and 230 mPa·s or less or so.

In the case of a spray coating method, when viscosity of a paint is too low, there is a possibility that a membrane having a thickness capable of bringing out predetermined performance cannot be formed. When viscosity of a paint is too high, it is liable to cause a disadvantage that a liquid does not come out from a nozzle or, even if it could come out, it cannot be atomized, etc. In the case of a dip coating method, when viscosity of a paint is too low, liquid dripping becomes intense and unevenness arises, so that there is a possibility that a preferable membrane cannot be formed in some cases. When viscosity of a paint is too high, drainage becomes poor when pulling out an object to be coated from a paint, and burr, etc. may be caused or it is liable that a shape of a surface of a coated membrane becomes flat, which results in causing glossiness in some cases. In the case of a dispenser method, when viscosity of a paint is too low, splash of the liquid and dripping of the liquid are caused so that there is a possibility that a paint is applied to parts, on which a paint should not be applied, in some cases. When viscosity of a paint is too high a liquid does not come out from a nozzle or, even if it comes out, there is a possibility that a shape of a surface becomes flat, which results in causing glossiness in some cases. In the case of filling a paint in a pen-type application tool, when viscosity of a paint is too low, it is liable of causing disadvantages that a membrane thickness becomes too thin and an optical concentration becomes insufficient, or a paint gets wet to spreads and it is not possible to draw a fine line, etc. When viscosity of a paint is too high, it is liable that disadvantages are caused, such that a liquid does not come out from a pen nib or a streak arises easily and it is not possible to draw a fine line, etc.

Viscosity of a paint differs depending on components contained in a composition in the paint, namely, kinds and molecular weights, etc. of (A) and (B) used for forming the composition, and it also differs depending on a kind and molecular weight, etc. of an optional component when an optional component is blended in addition to the (A) and (B) above, however, it can be adjusted easily by determining an amount of (C) in the paint properly.

### -Other Additives-

Other than the component (composition (C)) above, a paint may comprise one or more kinds of other additives as long as not hindering the effects of the present invention. As other additives, for example, a leveling agent, thickener, pH adjusting agent, lubricant, dispersant, defoaming agent, curing agent and reaction catalyst, etc. may be mentioned.

When blending other additive, a blending amount is, with respect to 100 parts by weight of a solid content of a resin in a paint, preferably 0 to 100 parts by weight and more preferably 0 to 30 parts by weight.

The paint above according to one mode may be used for applying to parts for building a model.

The paint above according to one mode may be used for applying to camera parts.

The paint above according to one mode may be used for applying in a spray coating method.

The paint above according to one mode may be used for applying in a method of using a pen-type application tool, for applying in a brush application method, for applying in a dip coating method or for applying in a dispenser method.

The paint according to one mode can be held in a pen-type application tool for use.

### <Application Method and Object to be Coated>

A membrane according to one mode of the present invention is formed by applying the paint to an object to be coated to form a coating film, then, drying the coating film.

An application method of the paint may be a spray coating method (for example, an air spray method, airless spray method and electrostatic spray method, etc.). When using a spray coating method, even if a surface of an object to be coated has a protruded or uneven portion, a membrane with a uniform thickness having specific properties can be formed allover the surface.

As an application condition using a spray coating method, preferably a caliber of a spray gun is 0.2 to 1.2 mm or so, an amount of a spraying liquid is 0.2 to 10 (g/minute) or so, a shortest distance between a spray gun and an application surface is 30 to 500 mm or so, an application rate is 30 to 300 (mm/second) or so, a superimposing pitch is 1.5 to 10 mm or so and a pressure of an atomizing air is 0.03 to 0.2 MPa or so. As the number of the spray guns, other than operating with a single gun, a plurality of guns may be arranged in accordance with a size of an object to be coated in terms of improving application efficiency.

After applying the paint above to a surface of an object to be coated, a solvent is removed by drying so as to form a membrane. In accordance with need, the coating film may be cured by irradiating an UV light or EB light or by heating.

Other than using a spray coating method, application of the paint may be, for example, by a method of using a pen-type application tool, such as a marking pen, a method of using a brush (brush painting), a dip coating (immersion) method or a dispenser method.

In one mode, a configuration of a pen-type application tool is not limited and, for example, one comprising a pen nib, paint filling mechanism, pen nib retraction mechanism and paint feeding mechanism, etc. may be mentioned.

As a pen nib of the application tool, a pen core, such as a fiber tip, felt tip and plastic tip, and a metal pen nib for a fountain pen, etc. may be mentioned besides a ballpoint pen tip, wherein a ball is held in a freely rotatable way in a ball housing (ball holding room) of a tip body.

A paint filling mechanism of an application tool may be configured to fill the paint directly or may be one provided with a paint container or a paint occluding body for filling the paint.

In the case where a paint filling mechanism is configured to fill the paint directly, in order to facilitate redispersion of (B), a stirring ball or other stirring body for stirring the paint is preferably incorporated in its paint container. As a shape of the stirring body, a spheric body and a stick-shaped body, etc. may be mentioned. A material of the stirring body is not particularly limited and, for example, a metal, ceramic, resin and glass, etc. may be mentioned.

In the case where a paint filling mechanism comprises a paint occluding body, the paint occluding body is preferably configured by a fiber bundled body formed by using twisted fiber.

A pen nib retraction mechanism of an application tool is not particularly limited and a cap type having a cap for covering the pen nib, knock type, rotation type and sliding type, etc. may be mentioned. Alternately, it may be a retraction type, by which a pen nib can be housed in a core cylinder.

Also, a paint feeding mechanism of an application tool is not particularly limited and, for example: a mechanism comprising a paint leading core made of a fiber bundle, etc. as a paint flow-amount adjusting member so as to feed the paint to the pen nib; a mechanism comprising a paint flow-amount adjusting member having comb-shaped grooves (serrations), through which the paint is fed to a pen nib; a mechanism, wherein a large number of disks are parallelly arranged at intervals of comb-shaped grooves (serrations), a paint leading slit-shaped groove penetrating the disks along an axis direction and a little wider groove for an air to pass are provided, and, through a pen core, wherein a paint leading core for leading a paint from a paint storage to a pen nib is arranged at a central axis, the paint is led to the pen nib.; a mechanism comprising a paint flow amount adjusting member using a valve mechanism so as to feed the paint to the pen nib; and a mechanism of feeding the paint directly to the pen nib from a paint container or an axial cylinder having a pen nib; etc. may be mentioned.

In one mode, a pen-type application tool may be a marking pen, such as a marker for painting a model-building kit, and its pen nib is not particularly limited and may be, for example, a fiber tip, felt tip or plastic tip, etc. and, furthermore, a shape thereof may be a bullet shape or a brush pen-type, etc.

In one mode, a pen-type application tool may be a pen body, comprising, in a cylindrical axial tube, a paint container, a stirring body incorporated in the paint container for stirring the paint and a valve mechanism for adjusting feed of the paint contained in the paint container to a pen nib, wherein the valve mechanism is opened by a pen nib pressing method so as to flowing the paint to the pen nib.

In the case where application of the paint is by brush painting, it is liable that a thickness of a membrane to be formed on a coating surface varies depending on a place to be formed, however, performance of a membrane to be obtained is equivalent to that in the case of other application methods. It is considered that it is because unevenness is formed due to a proper amount of a pigment contained therein, although the reason is not very clear.

An object to be applied with a paint (object to be coated) is not particularly limited as long as the object has a hard surface, for example, made of glass, a resin, metal, ceramic and wood, etc. A shape of the object to be coated is not particularly limited, and a plate shape, (hollow) cylinder shape and film shape, etc. may be mentioned.

As an object to be coated, for example, the followings may be mentioned.
electric/electronic devices, such as a cellular phone, smartphone, tablet, personal computer, peripheral appliances of personal computer (a keyboard, printer and external drive, etc.), watch, audio appliances, and a variety of office automation apparatuses
home electric appliances, such as a refrigerator, vacuum cleaner, microwave, television, and recording appliances
furniture and wooden products, such as stairs, floor, table, chair and closet
a variety of building materials, such as flooring, and inner wall/outer wall of building
vehicles, such as automobiles and motorcycles, and components thereof: specifically, body of vehicle, interiors (a meter panel, dashboard and handle, etc.), bumper, spoiler, doorknob, headlight, taillight, aluminum wheel, and gasoline tank of motorcycle, etc.
optical use, such as camera parts to be mounted to a variety of camera units, for example, a lens, lens barrel inner wall, inner/outer cover of a lens unit and spacer of lens, etc.
glasses, goggles and other similar products
hobby products made of resin mold parts and parts for building them (for example, a model for building (plastic model, etc.) and parts of model for building in the model kit, etc.)

### <Characteristics of Membrane>

Characteristics of a membrane formed from a composition according to one mode are as below.

(Glossiness, Reflectance, L value, Optical Density and Adhesiveness)

A membrane formed form the paint above preferably has glossiness of less than 1.0%, reflectance of less than 1.5% and an L value of less than 15 on its membrane surface. In the case where a light-shielding characteristic when transmitting light is required, it is furthermore preferable that an optical density on the membrane surface is 2.0 or more in addition to the above characteristics (glossiness of less than 1.0%, reflectance less than 1.5% and L value less than 15 on the membrane surface).

Here, when configured that a membrane formed from the paint above is exposed as an outermost surface, glossiness, reflectance, an L value and optical density on a real surface of the membrane are preferably in the ranges as above. On the other hand, when another membrane is coated on a membrane formed from the paint, glossiness, reflectance, an L value and optical density on a surface of this another membrane, that is, an outermost surface of the membrane formed on an object to be coated preferably has glossiness, reflectance, an L value and, as needed, an optical density in the ranges above. Hereinafter, these surfaces will be referred to as “an outermost surface of a membrane”.

An outermost surface of a membrane formed from the paint above preferably has glossiness of less than 1.0%, reflectance of less than 1.5% and an L value of less than 15. In the case where a light-shielding characteristic when transmitting a light is required, it is furthermore preferable that an optical density on the outermost surface of the membrane is 2.0 or more in addition to the above characteristics (glossiness of less than 1.0%, reflectance les than 1.5% and an L value less than 15 on the outermost surface of the membrane). When glossiness, reflectance, an L value and, as needed, an optical density on an outermost surface of a membrane are in the ranges as above, it is possible to attain low glossiness, low reflectance, a high blackness degree and, as needed, a high light-shielding characteristic on the outermost surface of the membrane.

The uppermost value of glossiness is more preferably less than 0.7% and furthermore preferably less than 0.5%. When glossiness is adjusted to be in the range above, a flare ghost phenomenon due to irregular reflection of lights can be prevented effectively. A lower limit value of glossiness is not particularly limited, and the lower the better.

An uppermost value of reflectance is more preferably less than 1.25% and furthermore preferably less than 1.0%. A lower limit value of reflectance is not particularly limited. The lower the reflectance is, the better. When reflectance is adjusted to be in the range above, a flare ghost phenomenon due to irregular reflection of lights can be prevented furthermore effectively.

An uppermost value of an L value (a blackness degree) is more preferably less than 12 and furthermore preferably less than 10. A lower limit value of an L value is not particularly limited, however, in terms of demands for real blackness on appearance, the lower, the better. When an L value is adjusted to be in the range above, the blackness is enhanced and blackness outstands so as to attain excellent designability, therefore, it can be preferably used as a camera unit, etc. for smartphones and other cellular phones.

The L value above is a lightness L*value on an outermost surface of a membrane, which is in CIE 1976 L*a*b* (CIELAB) color space system based on a SCE method. The SCE method is a specularly reflected light removal method, which means a method of measuring color by removing specularly reflected lights. Definition of the SCE method is defined in JIS Z8722 (2009). Since specularly reflected lights are removed in the SCE method, the color is close to the color actually viewed by human.

CIE is abbreviation of Commission Internationale de l'Eclairage, which means international committee on illumination. The CIELAB color space was adopted in 1976 in order to measure color difference between perception and devices and is a uniform color space defined in JIS Z 8781 (2013). Three coordinates in CIELAB are indicated by L*value, a*value and b*value. The L*value indicates lightness and expressed from 0 to 100. When L*value is 0, it indicates black, while it indicates white diffusion color when L*value is 100. The a*value indicates colors between red and green. When a*value is in minus, it indicates colors close to green, while when in plus, it indicates colors close to red. The b*value indicates colors between yellow and blue. When b*value is in minus, it indicates colors close to blue, while it indicates colors close to yellow when in plus.

A lower limit value of an optical density in the case, where a light-shielding characteristic when transmitting light is required to a membrane formed from a composition, is more preferably 2.5 or more and furthermore preferably 3.2 or more. When optical density is adjusted to be in the range above, a light-shielding characteristic can be enhanced furthermore. An upper limit value of an optical density is not particularly limited, and the higher the better.

The glossiness, reflectance, an L value and optical density explained above can be measured by methods explained later on.

In addition to the characteristics (glossiness, reflectance, an L value and, when necessary, optical density) above, a membrane formed from the paint above preferably has good adhesiveness to a surface of an object to be coated. Adhesiveness of a membrane formed from the paint to a surface of an object to be coated preferably satisfies that 90% or more of the coating remain as explained in adhesiveness evaluation in later-explained examples.

### EXAMPLES

Below, the present invention will be explained specifically based on examples (including modes and comparative examples), however, the present invention is not limited to the examples. Below, “part” indicates “part by mass” and “%” indicates “% by mass”.

### [Components of Water-Based Paint]

As A (a resin component), substances below were prepared.
A1a: acrylic resin emulsion (Mowinyl 7471 by Mitsubishi Chemical Corporation)
   (an acrylic acid ester copolymer, resin Tg 23° C., resin solid content 44%)
A2a: polyester-based resin emulsion (VYLONAL MD1200 by TOYOBO Co., Ltd.)
   (a resin Tg 67° C., resin solid content 34%, Mn 15,000, acid number 1 mgKOH/g, hydroxyl number 5 mgKOH/g)
A3a: polyvinyl alcohol (Gohsenol KH17 by Mitsubishi Chemical Corporation)
   (a resin solid content 15%, polymerization degree 1700 or so, saponification degree 78.5 to 81.5 mol %)

By using a mixture obtained by mixing a resin solid content in “Mowinyl 7471” (acrylic resin) used as Ala and a resin solid content in “VYKONAL MD1200” (polyester-based resin) used as A2a (both emulsions) at a mass ratio of 1:1, a haze value of a membrane (thickness 12 μm) formed from the mixture was measured by using a hazemeter (NDH4000 by NIPPON DENSHOKU Industries Co., Ltd.) in the method based on JISK7136, and it was 3.85%. After that, with respect to a resin solid content of A1a: 1, a ratio of a resin solid content of A2a was changed to 1.23, 2.94 and 12.25, and a haze value of each of the formed membranes was measured in the same method as above. The results were 4.72%, 8.55% and 15.82%, respectively. It was confirmed that the haze value increases as a mixed amount of A2a increases.

As B (a black material), the followings were prepared.
B1a: black acrylic beads (a particle diameter 2 to 3 μm)
   (RUBCOULEUR 224 (SMD) black, by Dainichiseika Color & Chemicals Mfg Co., Ltd., a CB content 18%)
B2a: black acrylic beads (a particle diameter 7 to 9 μm)
   (RUBCOULEUR 220 (MD) black, by Dainichiseika Color & Chemicals Mfg Co., Ltd., a CB content 5%)
B2b: CB (a particle diameter 150 nm)
   (MHI black_#273, by MIKUNI Color Ltd., a CB content 9.5%)
B2c: composite silica (a particle diameter 3 μm)
   (BECSIA ID, by Fuji Silysia Chemical Ltd.)

Note that “RUBCOULER 224 (SMD) black” used as B1a and “RUBCOULER 220 (MD) black” used as B2a are spherical acrylic resin particles containing CB and are composites of CB and an acrylic resin. “MHI black_#273” used as B2b (CB) is a CB dispersion liquid, wherein 9.5% is CB and the residual 8.5% is other compound in a total solid content of 18% in the dispersion liquid. In the residual compound 8.5%, 3% is a copper compound and 5.5% is an acrylic resin. “BECSIA ID” used as B2c (composite silica) is a composite particle of CB and silica, wherein CB/silica=25/75 (mass ratio) or so.

As C (a diluting solvent), the followings were prepared.
C1: water
C2: alcohol

### [Object to be Coated]

An object to be coated, a chassis (a plastic exterior) of a smartphone was prepared.

### Examples 1 to 23 and 4a to 17a

### 1. Preparation of Water-Based Paint

In a mixed solvent of water and alcohol in a predetermined amount as shown in Table 1 and Table 2, respective components for each example were put in, so that a solid content ratio of a total solid content (% by mass) and solid contents of each of the respective components become values described in Tables 1 to 3, and mixed by agitating so as to prepare a water-based paint (hereinafter, also simply referred to as “a paint”).

### 2-1. Formation of Membrane 1

Each paint obtained for each example was sprayed against an object to be coated by a spray coating method in the same way as in (3-3-1) Applicability 1 below so as to form a coating film, then, the coating film was left still for 5 to 10 minutes at a normal temperature, so that a membrane 1 having an average film thickness of 20 μm was formed by spray coating method on a surface of an object to be coated.

### 2-2 Formation of Membrane 2

By using a marking pen used in (3-3-2) Applicability 2 below, a coating film was formed by painting allover an object to be coated in the same way, then, the coating film was left still for 5 to 10 minutes at a normal temperature, so that a membrane 2 having an average thickness of 10 μm was formed by painting on a surface of an object to be coated.

### 3. Evaluation

On each paint obtained in each of the examples, a variety of characteristics (viscosity, injection performance, applicability 1, applicability 2 and a liquid dripping characteristic) were evaluated (paint evaluation) in the methods explained below. Also, on a membrane 1 and membrane 2 formed from a paint obtained for each of the examples, a variety of characteristics (properties) were evaluated (membrane evaluation) in the methods explained below. The results are shown in Tables 1 to 3.

### [Paint Evaluation]

### (3-1-1) Viscosity 1

Viscosity 1 of a paint was measured by using a B-type viscometer (VISCOMETER BM2 produced by TOKISANGYO) under a condition of 60 rpm with a No. 1 rotor after one minute at 25° C. Evaluation reference is as below.
◯: Viscosity was 1 mPa·s or more and 50 mPa·s or less. (preferable viscosity)
x: Viscosity exceeded 50 mPa·s. (excessively high viscosity)

### (3-1-2) Viscosity 2

Viscosity 2 of a paint was measured by using a B-type viscometer (VISCOMETER BM2 produced by TOKISANGYO) under a condition of 60 rpm with a No. 2 rotor after one minute at 25° C. Evaluation reference is as below.
◯: Viscosity was 80 mPa·s or more and 230 mPa·s or less. (preferable viscosity)
x: Viscosity exceeded 230 mPa·s. (excessively high viscosity)

### (3-2) Injection Performance

Injection performance was evaluated by observing a state of injecting the paint to an air spray.

An air spray, wherein an air brush (Spray-Work HG Single Airbrush, by TAMIYA, Inc.) was attached to an air can (Spray-Work Air Can 420D, by TAMIYA, Inc.), was used and a state that each paint enters from a cup of an air brush to a nozzle was observed visually and injection performance was evaluated. Evaluation reference is as below.
◯: A paint entered smoothly to the nozzle with no clogging.
Δ: There was no clogging but speed of the paint entering to the nozzle was slow.
x: A paint clogged and did not enter the nozzle.

### (3-3-1) Applicability 1

Applicability 1 of a paint was evaluated by observing coating unevenness after applying by a spray coating method. Each paint was poured into an air spray used in (3-2) above, atomizing from a tip of the air brush toward an outer surface of an object to be coated from a 10 cm distance for 10 seconds, and application unevenness on a coating film (before drying) was evaluated visually.

### (3-3-2) Applicability 2

Applicability 2 of a paint was evaluated by observing coating unevenness painted by a marking pen. In a cylindrical core tube of a liquid-type pen body, wherein a valve is opened by pressing a pen nib so that a liquid flows to a pen nib (Uni-Posca PC-1M, by Mitsubishi Pencil Co., Ltd.), a paint obtained for each of the examples was filled together with a stainless ball for stirring (a diameter 5 mm), then, assembled, so that a marking pen having a pen nib polished to be a chisel type was produced. This marking pen was used to paint all of a range of 2 cm square on an object to be coated by painting in one vertical direction, and coating unevenness on a formed coating film (before drying) was evaluated visually.

Evaluation reference of applicability 1 and applicability 2 is as below.
⊚: Coating unevenness (unevenness in thickness) was not observed.
◯: Coating unevenness was observed partially.
x: Coating unevenness was observed in many areas.

### (3-4) Liquid Dripping Characteristic

A liquid dripping characteristic of a paint was evaluated by observing liquid dripping from an object to be coated after applying by a spray coating method.

In the same way as in (3-3-1) above, each paint was poured into the air spray used in (3-2) above, and after atomizing from a tip of the air brush toward an outer surface of an object to be coated for 10 seconds from a 10 cm distance, a liquid dripping characteristic of adhered droplets from the object to be coated was evaluated. Evaluation reference is as below.
◯: Even when a coated object was placed vertically, there was no dripping.
Δ: When a coated object was placed vertically, the liquid dripped gradually.
x: When a coated object was placed vertically, the liquid started to drip immediately.

### [Membrane Evaluation]

### (3-5) Characteristics

### -Glossiness-

Glossiness against a measurement light having an incident angle of 60° (specular glossiness at) 60° on a surface of each of a membrane 1 and membrane 2 formed on each object to be coated was measured on 9 spots by using a glossmeter (VG 7000, by NIPPON DENSHOKU Industries Co., Ltd.) by the method based on JIS Z8741, and an average value thereof was adopted as a glossiness degree. Evaluation reference is as below.
⊚: A glossiness degree was less than 0.5%. (extremely excellent low glossiness)
◯: A glossiness degree was 0.5% or more but less than 0.7%. (excellent low glossiness)
Δ: A glossiness degree was 0.7% or more but less than 1.0% (preferably low glossiness)
λ: A glossiness degree was 1.0% or more. (not low enough glossiness)

### -Reflectance-

Reflectance against a light having a wavelength of 550 nm (550 nm reflectance) on each surface of a membrane 1 and membrane 2 formed on each object to be coated was measured at 9 spots by using a special colorimeter (CM-5, by Konica Minolta Inc.) by the method based on JIS Z8722, and an average value thereof was adopted as reflectance. Evaluation reference is as below.
⊚: Reflectance was less than 1.0% (extremely excellent low reflectance)
◯: Reflectance was 1.0% or more but less than 1.25%. (excellent low reflectance)
Δ: Reflectance was 1.25% or more but less than 1.5% (preferable low reflectance)
x: Reflectance was 1.5% or more. (not low enough reflectance)

### -Blackness Degree-

A degree of blackness on each surface of a membrane 1 and membrane 2 formed on each object to be coated was evaluated by measuring lightness L*value in CIE 1976 L*a*b* (CIELAB) color space system on the membrane surface by the SCE method. The lightness L*value was measured by using a spectral colorimeter (CM-5, by Konica Minolta Inc.) by the method based on JIS Z8781-4:2013. Evaluation reference is as below.

When measuring, a CIE standard light source D65 was used as a light source and an L* value in the CIELAB color space system was obtained at a viewing angle of 10° by the SCE method. The CIE standard light source D65 is defined in JIS Z8720 (2000) “Standard Illuminants and Sources for Colorimetry”, and ISO 10526 (2007) also shows the same definition. The CIE standard light source D65 is used in the case of displaying colors of an object illuminated by daylight. A viewing angle of 10° is defined in JIS Z8723 (2009) “Methods of Visual Comparison for Surface Colours”, and ISO/DIS 3668 also shows the same definition.
⊚: An L value was less than 10. (extremely excellent blackness degree)
◯: An L value was 10 or more but less than 12. (excellent blackness degree)
Δ: An L value was 12 or more but less than 15 (preferable blackness degree)
x: An L value was 15 or more. (insufficient blackness degree)

### -Light-Shielding Characteristic-

A light-shielding characteristic of a membrane 1 and membrane 2 formed on each object to be coated was evaluated by calculating an optical density of each membrane. An optical density of each of the membranes 1 and 2 formed on respective objects to be coated was obtained by using an optical density meter (X-rite 361T (ortho filter), by Nihon Heihan Kizai Kabushiki Kaisha), irradiating a vertical transmission light flux to the membrane side of an object to be coated, and calculating by expressing a ratio with respect to a state without a membrane in log (logarithms). An optical density of 6.0 or more is an upper limit value of detection in the measurement. Evaluation reference is as below. Note that this evaluation is on an assumption that an object to be coated itself has transmissivity and that a membrane formed thereon requires a light-shielding characteristic. When the membrane is not required to have any light-shielding characteristic, an evaluation here does not affect comprehensive evaluation thereof.
⊚: An optical density was 3.2 or more. (extremely excellent light-shielding characteristic)
◯: An optical density was 2.5 or more but less than 3.0. (excellent light-shielding characteristic)
Δ: An optical density was 2.0 or more but less than 2.5. (preferable light-shielding characteristic)
x: An optical density was less than 2.0. (insufficient light-shielding characteristic)

### -Adhesiveness-

Adhesiveness of each of membranes 1 and 2 formed on respective objects to be coated to respective surfaces of the objects to be coated was evaluated by cutting a membrane in a grid pattern with a market-available cutter, putting thereon a cellophane tape (Cellulose tape produced by NICHIBAN Co., Ltd.), then taking off the tape, and visually observing a remaining state of the membrane. Evaluation reference is as below.
⊚: A membrane remained 100%. (extremely excellent adhesiveness)
◯: A membrane remained 95% or more and less than 100%. (excellent adhesiveness)
Δ: A membrane remained 90% or more and less than 95% (preferable adhesiveness)
x: A coating film remained less than 90%. (insufficient adhesiveness)

### -Comprehensive Evaluation-

Glossiness, reflectance, a blackness degree and adhesiveness explained above were evaluated comprehensively. Evaluation reference is as below. Note that a light-shielding characteristic was omitted from the comprehensive evaluation because, as explained above, it is required in some cases but not required in other cases.
⊚: Evaluations on glossiness, reflectance, a blackness degree and adhesiveness were all ⊚.
◯: At least one of the evaluations on glossiness, reflectance, a blackness degree and adhesiveness was ◯, but there was no x.
x: At least one of the evaluations on glossiness, reflectance, a blackness degree and adhesiveness was x.

TABLE 1

| | | | | | | EXAMPLES | | | | | | | | | | | | | | | | | | |
|---|---|---|---|---|---|---|---|---|---|---|---|---|---|---|---|---|---|---|---|---|---|---|---|---|
| | | COMPONENTS | | | | 1 | 2 | 3 | 4 | 5 | 6 | 7 | 8 | 9 | 10 | 6 | 11 | 12 | 13 | 14 | 15 | 6 | 16 | 17 |
| PAINT | COMPO- | A | A1 | A1a | ACRYLIC | 1.76 | 1.71 | 5.56 | 1.61 | 2.58 | 2.70 | 1.48 | 1.89 | 0.85 | 1.08 | 2.70 | 2.70 | 2.70 | 2.70 | 2.70 | 2.70 | 2.70 | 2.70 | 2.70 |
| COMPO- | SITION | | | | RESIN | | | | | | | | | | | | | | | | | | | |
| SITION | | | | | EMULSION | | | | | | | | | | | | | | | | | | | |
| | | | A2 | A2a | POLYESTER- | 0 | 0 | 0 | 2.74 | 4.79 | 5.74 | 4.00 | 6.57 | 3.70 | 4.86 | 5.74 | 5.74 | 5.74 | 5.74 | 5.74 | 5.74 | 5.74 | 5.74 | 5.74 |
| | | | | | BASED | | | | | | | | | | | | | | | | | | | |
| | | | | | RESIN | | | | | | | | | | | | | | | | | | | |
| | | | | | EMULSION | | | | | | | | | | | | | | | | | | | |
| | | | A3 | A3a | POLYVINYL | 0.22 | 0.64 | 0.90 | 0 | 0 | 0 | 2.12 | 2.32 | 1.43 | 2.07 | 0 | 0 | 0 | 0 | 0 | 0 | 0 | 0 | 0 |
| | | | | | ALCOHOL | | | | | | | | | | | | | | | | | | | |
| | | | ※A1:A2 = 1:● | | | 0 | 0 | 0 | 1.70 | 1.85 | 2.12 | 2.70 | 3.48 | 4.33 | 4.49 | 2.12 | 2.12 | 2.12 | 2.12 | 2.12 | 2.12 | 2.12 | 2.12 | 2.12 |
| | | | (MASS RATIO) | | | | | | | | | | | | | | | | | | | | | |
| | | | ※A1:A3 = 1:● | | | 0.12 | 0.37 | 0.16 | 0 | 0 | 0 | 1.43 | 1.23 | 1.67 | 1.91 | 0 | 0 | 0 | 0 | 0 | 0 | 0 | 0 | 0 |
| | | | (MASS RATIO) | | | | | | | | | | | | | | | | | | | | | |
| | | | ※(A + B):A = 100:● | | | 9.8 | 11.7 | 30.3 | 43.7 | 41.9 | 29.2 | 31.1 | 28.8 | 21.4 | 28.4 | 29.2 | 29.2 | 29.2 | 29.2 | 45.8 | 39.4 | 29.2 | 27.7 | 19.0 |
| | | | (MASS RATIO) | | | | | | | | | | | | | | | | | | | | | |
| | | B | B1 | B1a | BLACK | 18.18 | 17.67 | 14.88 | 5.60 | 10.20 | 20.48 | 16.87 | 26.61 | 22.00 | 20.20 | 20.48 | 0 | 0 | 0 | 10.00 | 13.00 | 20.48 | 22.00 | 36.00 |
| | | | | | ACRYLIC | | | | | | | | | | | | | | | | | | | |
| | | | | | BEADS | | | | | | | | | | | | | | | | | | | |
| | | | | | (3 μm) | | | | | | | | | | | | | | | | | | | |
| | | | OTHER | B2a | BLACK | 0 | 0 | 0 | 0 | 0 | 0 | 0 | 0 | 0 | 0 | 0 | 20.48 | 0 | 0 | 0 | 0 | 0 | 0 | 0 |
| | | | THAN | | ACRYLIC | | | | | | | | | | | | | | | | | | | |
| | | | B1 | | BEADS | | | | | | | | | | | | | | | | | | | |
| | | | | | (7-9 μm) | | | | | | | | | | | | | | | | | | | |
| | | | | B2b | CARBON | 0 | 0 | 0 | 0 | 0 | 0 | 0 | 0 | 0 | 0 | 0 | 0 | 20.48 | 0 | 0 | 0 | 0 | 0 | 0 |
| | | | | | BLACK | | | | | | | | | | | | | | | | | | | |
| | | | | | (150 nm) | | | | | | | | | | | | | | | | | | | |
| | | | | B2c | COMPOSITE | 0 | 0 | 0 | 0 | 0 | 0 | 0 | 0 | 0 | 0 | 0 | 0 | 0 | 20.48 | 0 | 0 | 0 | 0 | 0 |
| | | | | | SILICA | | | | | | | | | | | | | | | | | | | |
| | | | | | (3 μm) | | | | | | | | | | | | | | | | | | | |

| | ※A:B = 1:● (MASS RATIO) | | 9.19 | 7.53 | 2.30 | 1.29 | 1.38 | 2.43 | 2.22 | 2.47 | 3.68 | 2.52 | 2.43 | 2.43 | 2.43 | 2.43 | 1.19 | 1.54 | 2.43 | 2.61 | 4.27 |
|---|---|---|---|---|---|---|---|---|---|---|---|---|---|---|---|---|---|---|---|---|---|
| | ※(A + B):B = 100:● | | 90.2 | 88.3 | 69.7 | 56.3 | 58.1 | 70.8 | 68.9 | 71.2 | 78.6 | 71.6 | 70.8 | 70.8 | 70.8 | 70.8 | 54.2 | 60.6 | 70.8 | 72.3 | 81.0 |
| | (MASS RATIO) | | | | | | | | | | | | | | | | | | | | |
| C | C1 | WATER | 30.54 | 29.62 | 26.13 | 15.00 | 30.00 | 44.00 | 45.00 | 76.00 | 49.50 | 24.63 | 44.00 | 41.00 | 47.00 | 41.00 | 28.26 | 28.26 | 44.00 | 43.50 | 63.00 |
| | C2 | ALCOHOL | 45.85 | 44.52 | 40.36 | 15.00 | 30.00 | 44.00 | 45.00 | 76.00 | 49.50 | 24.63 | 44.00 | 41.00 | 47.00 | 41.00 | 28.26 | 28.26 | 44.00 | 43.50 | 63.00 |

| | | | | | | | | | | | | | | | | | | | |
|---|---|---|---|---|---|---|---|---|---|---|---|---|---|---|---|---|---|---|---|
| TOTAL SOLID CONTENT (%) | 20 | 20 | 21 | 21 | 19 | 22 | 18 | 17 | 20 | 28 | 22 | 23 | 21 | 23 | 21 | 23 | 22 | 23 | 24 |

| | | | | | | | | | | | | | | | | | | | | | |
|---|---|---|---|---|---|---|---|---|---|---|---|---|---|---|---|---|---|---|---|---|---|
| CHARAC- | PAINT | VISCOSITY 1 (mPa · s) | ◯ | ◯ | ◯ | ◯ | ◯ | ◯ | ◯ | ◯ | ◯ | X | ◯ | ◯ | ◯ | ◯ | ◯ | ◯ | ◯ | ◯ | ◯ |
| TERISTIC | | INJECTION | ◯ | ◯ | ◯ | ◯ | ◯ | ◯ | ◯ | ◯ | ◯ | X | ◯ | ◯ | ◯ | ◯ | ◯ | ◯ | ◯ | ◯ | ◯ |
| EVALUATION | | PERFORMANCE | | | | | | | | | | | | | | | | | | | |
| | | APPLICABILITY 1 | ◯ | ◯ | ◯ | ◯ | ⊚ | ⊚ | ◯ | ◯ | ◯ | X | ⊚ | ◯ | ⊚ | X | ◯ | ◯ | ⊚ | ⊚ | X |
| | | (SPRAY COATING) | | | | | | | | | | | | | | | | | | | |
| | | LIQUID DRIPPING | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ | ◯ |
| | | CHARACTERISTIC | | | | | | | | | | | | | | | | | | | |
| | MEM- | GLOSSINESS | ⊚ | ⊚ | ⊚ | ⊚ | ⊚ | ⊚ | ⊚ | ⊚ | ⊚ | ⊚ | ⊚ | ⊚ | X | ⊚ | Δ | Δ | ⊚ | ⊚ | ⊚ |
| | BRANE | (SPECULAR | | | | | | | | | | | | | | | | | | | |
| | CHARAC- | GLOSSINESS AT 60°) | | | | | | | | | | | | | | | | | | | |
| | TERISTICS | REFLECTANCE | ◯ | ⊚ | X | ⊚ | ⊚ | ⊚ | ⊚ | ⊚ | ◯ | ◯ | ⊚ | Δ | X | ◯ | X | ◯ | ⊚ | ⊚ | ◯ |
| | | (550 nm REFLECTANCE) | | | | | | | | | | | | | | | | | | | |
| | | L VALUE | ◯ | ◯ | X | ◯ | ◯ | ⊚ | ◯ | ◯ | ◯ | ◯ | ⊚ | X | X | ◯ | X | ◯ | ⊚ | ⊚ | ◯ |
| | | (L* VALUE IN CIELAB | | | | | | | | | | | | | | | | | | | |
| | | COLOR SPACE SYSTEM) | | | | | | | | | | | | | | | | | | | |
| | | LIGHT-SHIELDING | ◯ | ◯ | X | ◯ | ◯ | ⊚ | ◯ | ◯ | ◯ | ◯ | ⊚ | X | ⊚ | ◯ | ◯ | ◯ | ⊚ | ◯ | Δ |
| | | CHARACTERISTIC | | | | | | | | | | | | | | | | | | | |
| | | ADHESIVENESS | X | X | ◯ | X | ◯ | ◯ | ⊚ | ⊚ | ◯ | X | ◯ | ⊚ | X | X | ◯ | ◯ | ◯ | ◯ | X |
| | | ※COMPREHENSIVE | X | X | X | X | ◯ | ⊚ | ◯ | ◯ | ◯ | X | ⊚ | X | X | X | X | ◯ | ⊚ | ◯ | X |
| | | EVALUATION | | | | | | | | | | | | | | | | | | | |

TABLE 2

| | | | | | | EXAMPLES | | | | | | | | | | | | | | | |
|---|---|---|---|---|---|---|---|---|---|---|---|---|---|---|---|---|---|---|---|---|---|
| | | COMPONENTS | | | | 4a | 5a | 6a | 7a | 8a | 9a | 10a | 6a | 11a | 12a | 13a | 14a | 15a | 6a | 16 | 17a |
| PAINT | COMPOSITION | A | A1 | A1a | ACRYLIC | 1.61 | 2.58 | 2.70 | 1.48 | 1.89 | 0.85 | 1.08 | 2.70 | 2.70 | 2.70 | 2.70 | 2.70 | 2.70 | 2.70 | 2.70 | 2.70 |
| COMPOSITION | | | | | RESIN | | | | | | | | | | | | | | | | |
| | | | | | EMULSION | | | | | | | | | | | | | | | | |
| | | | A2 | A2a | POLY - | 2.74 | 4.79 | 5.74 | 4.00 | 6.57 | 3.70 | 4.86 | 5.74 | 5.74 | 5.74 | 5.74 | 5.74 | 5.74 | 5.74 | 5.74 | 5.74 |
| | | | | | ESTER- | | | | | | | | | | | | | | | | |
| | | | | | BASED | | | | | | | | | | | | | | | | |
| | | | | | RESIN | | | | | | | | | | | | | | | | |
| | | | | | EMULSION | | | | | | | | | | | | | | | | |
| | | | A3 | A3a | POLY- | 0 | 0 | 0 | 2.12 | 2.32 | 1.43 | 2.07 | 0 | 0 | 0 | 0 | 0 | 0 | 0 | 0 | 0 |
| | | | | | VINYL | | | | | | | | | | | | | | | | |
| | | | | | ALCOHOL | | | | | | | | | | | | | | | | |
| | | | ※A1:A2 = 1:● | | | 1.70 | 1.85 | 2.12 | 2.70 | 3.48 | 4.33 | 4.49 | 2.12 | 2.12 | 2.12 | 2.12 | 2.12 | 2.12 | 2.12 | 2.12 | 2.12 |
| | | | (MASS RATIO) | | | | | | | | | | | | | | | | | | |
| | | | ※A1:A3 = 1 ● | | | 0 | 0 | 0 | 1.43 | 1.23 | 1.67 | 1.91 | 0 | 0 | 0 | 0 | 0 | 0 | 0 | 0 | 0 |
| | | | (MASS RATIO) | | | | | | | | | | | | | | | | | | |
| | | | ※(A + B):A = 100:● | | | 43.7 | 41.9 | 29.2 | 31.1 | 28.8 | 21.4 | 28.4 | 29.2 | 29.2 | 29.2 | 29.2 | 45.8 | 39.4 | 29.2 | 27.7 | 19.0 |
| | | | (MASS RATIO) | | | | | | | | | | | | | | | | | | |
| | | B | B1 | B1a | BLACK | 5.60 | 10.20 | 20.48 | 16.87 | 26.61 | 22.00 | 20.20 | 20.48 | 0 | 0 | 0 | 10.00 | 13.00 | 20.48 | 22.00 | 36.00 |
| | | | | | ACRYLIC | | | | | | | | | | | | | | | | |
| | | | | | BEADS | | | | | | | | | | | | | | | | |
| | | | | | (3 μm) | | | | | | | | | | | | | | | | |
| | | | OTHER | B2a | BLACK | 0 | 0 | 0 | 0 | 0 | 0 | 0 | 0 | 20.48 | 0 | 0 | 0 | 0 | 0 | 0 | 0 |
| | | | THAN | | ACRYLIC | | | | | | | | | | | | | | | | |
| | | | B1 | | BEADS | | | | | | | | | | | | | | | | |
| | | | | | (7-9 μm) | | | | | | | | | | | | | | | | |
| | | | | B2b | CARBON | 0 | 0 | 0 | 0 | 0 | 0 | 0 | 0 | 0 | 20.48 | 0 | 0 | 0 | 0 | 0 | 0 |
| | | | | | BLACK | | | | | | | | | | | | | | | | |
| | | | | B2c | COM- | 0 | 0 | 0 | 0 | 0 | 0 | 0 | 0 | 0 | 0 | 20.48 | 0 | 0 | 0 | 0 | 0 |
| | | | | | POSITE | | | | | | | | | | | | | | | | |
| | | | | | SILICA | | | | | | | | | | | | | | | | |
| | | | | | (3 μm) | | | | | | | | | | | | | | | | |

| | ※A:B = 1:● | | 1.29 | 1.38 | 2.43 | 2.22 | 2.47 | 3.68 | 2.52 | 2.43 | 2.43 | 2.43 | 2.43 | 1.19 | 1.54 | 2.43 | 2.61 | 4.27 |
|---|---|---|---|---|---|---|---|---|---|---|---|---|---|---|---|---|---|---|
| | (MASS RATIO) | | | | | | | | | | | | | | | | | |
| | ※(A + B):B = 100:● | | 56.3 | 58.1 | 70.8 | 68.9 | 71.2 | 78.6 | 71.6 | 70.8 | 70.8 | 70.8 | 70.8 | 54.2 | 60.6 | 70.8 | 72.3 | 81.0 |
| | (MASS RATIO) | | | | | | | | | | | | | | | | | |
| C | C1 | WATER | 11.00 | 14.50 | 30.00 | 30.00 | 50.00 | 35.00 | 16.00 | 30.00 | 20.00 | 35.00 | 31.00 | 10.00 | 14.00 | 30.00 | 31.00 | 60.00 |
| | C2 | ALCOHOL | 11.00 | 14.50 | 30.00 | 30.00 | 50.00 | 35.00 | 16.00 | 30.00 | 20.00 | 35.00 | 31.00 | 10.00 | 14.00 | 30.00 | 31.00 | 60.00 |

| | | | | | | | | | | | | | | | | |
|---|---|---|---|---|---|---|---|---|---|---|---|---|---|---|---|---|
| TOTAL SOLID CONTENT (%) | 25 | 30 | 28 | 23 | 23 | 24 | 34 | 28 | 35 | 25 | 27 | 35 | 33 | 28 | 28 | 25 |

| | | | | | | | | | | | | | | | | | | |
|---|---|---|---|---|---|---|---|---|---|---|---|---|---|---|---|---|---|---|
| CHARACTERISTIC | PAINT | VISCOSITY 2 (mPa · s) | ◯ | ◯ | ◯ | ◯ | ◯ | ◯ | X | ◯ | ◯ | ◯ | ◯ | ◯ | ◯ | ◯ | ◯ | ◯ |
| EVALUATION | | APPLICABILITY 2 | ◯ | ⊚ | ⊚ | ◯ | ◯ | ◯ | X | ⊚ | ◯ | ⊚ | X | ◯ | ◯ | ⊚ | ⊚ | X |
| | | (MARKING PEN) | | | | | | | | | | | | | | | | |
| | MEMBRANE | GLOSSINESS | ⊚ | ⊚ | ⊚ | ⊚ | ⊚ | ⊚ | ⊚ | ⊚ | ⊚ | X | ⊚ | Δ | Δ | ⊚ | ⊚ | ⊚ |
| | CHARACTERISTICS | (SPECULAR | | | | | | | | | | | | | | | | |
| | | GLOSSINESS AT 60°) | | | | | | | | | | | | | | | | |
| | | REFLECTANCE | ⊚ | ⊚ | ⊚ | ⊚ | ⊚ | ◯ | ◯ | ⊚ | Δ | X | ◯ | X | ◯ | ⊚ | ⊚ | ◯ |
| | | (550 nm REFLECTANCE) | | | | | | | | | | | | | | | | |
| | | L VALUE (L* VALUE | ◯ | ◯ | ⊚ | ◯ | ◯ | ◯ | ◯ | ⊚ | X | X | ◯ | X | ◯ | ⊚ | ⊚ | ◯ |
| | | IN CIELAB | | | | | | | | | | | | | | | | |
| | | COLOR SPACE SYSTEM) | | | | | | | | | | | | | | | | |
| | | LIGHT-SHIELDING | ◯ | ◯ | ⊚ | ◯ | ◯ | ◯ | ◯ | ⊚ | X | ⊚ | ◯ | ◯ | ◯ | ⊚ | ◯ | Δ |
| | | CHARACTERISTIC | | | | | | | | | | | | | | | | |
| | | ADHESIVENESS | X | ◯ | ◯ | ⊚ | ⊚ | ◯ | X | ◯ | ⊚ | X | X | ◯ | ◯ | ◯ | ◯ | X |
| | | ※COMPREHENSIVE | X | ◯ | ⊚ | ◯ | ◯ | ◯ | X | ⊚ | X | X | X | X | ◯ | ⊚ | ◯ | X |
| | | EVALUATION | | | | | | | | | | | | | | | | |

TABLE 3

| | | | | | | EXAMPLES | | | | | | |
|---|---|---|---|---|---|---|---|---|---|---|---|---|
| | | COMPONENTS | | | | 18 | 19 | 20 | 21 | 22 | 6 | 23 |
| PAINT | COMPO- | A | A1 | A1a | ACRYLIC | 8.44 | 4.22 | 3.50 | 3.00 | 2.90 | 2.70 | 2.00 |
| COMPO- | SITION | | | | RESIN | | | | | | | |
| SITION | | | | | EMULSION | | | | | | | |
| | | | A2 | A2a | POLYESTER- | 0 | 4.22 | 4.94 | 5.44 | 5.54 | 5.74 | 6.44 |
| | | | | | BASED | | | | | | | |
| | | | | | RESIN | | | | | | | |
| | | | | | EMULSION | | | | | | | |
| | | | A3 | A3a | POLYVINYL | 0 | 0 | 0 | 0 | 0 | 0 | 0 |
| | | | | | ALCOHOL | | | | | | | |
| | | | ※A1:A2 = 1:● (MASS RATIO) | | | 0 | 1.00 | 1.41 | 1.81 | 1.91 | 2.12 | 3.22 |
| | | | ※A1:A3 = 1:● (MASS RATIO) | | | 0 | 0 | 0 | 0 | 0 | 0 | 0 |
| | | | ※(A + B):A = 100:● | | | 29.2 | 29.2 | 29.2 | 29.2 | 29.2 | 29.2 | 29.2 |
| | | | (MASS RATIO) | | | | | | | | | |
| | | B | B1 | B1a | BLACK | 20.48 | 20.48 | 20.48 | 20.48 | 20.48 | 20.48 | 20.48 |
| | | | | | ACRYLIC | | | | | | | |
| | | | | | BEADS (3 μm) | | | | | | | |
| | | | OTHER | B2a | BLACK | 0 | 0 | 0 | 0 | 0 | 0 | 0 |
| | | | THAN | | ACRYLIC | | | | | | | |
| | | | B1 | | BEADS | | | | | | | |
| | | | | | (7-9 μm) | | | | | | | |
| | | | | B2b | CARBON | 0 | 0 | 0 | 0 | 0 | 0 | 0 |
| | | | | | BLACK | | | | | | | |
| | | | | B2c | COMPOSITE | 0 | 0 | 0 | 0 | 0 | 0 | 0 |
| | | | | | SILICA | | | | | | | |
| | | | | | (3 μm) | | | | | | | |

| | ※A:B = 1:● (MASS RATIO) | | 2.43 | 2.43 | 2.43 | 2.43 | 2.43 | 2.43 | 2.43 |
|---|---|---|---|---|---|---|---|---|---|
| | ※(A + B):B = 100:● | | 70.8 | 70.8 | 70.8 | 70.8 | 70.8 | 70.8 | 70.8 |
| | (MASS RATIO) | | | | | | | | |
| C | C1 | WATER | 50.00 | 48.00 | 46.00 | 60.00 | 65.00 | 44.00 | 68.00 |
| | C2 | ALCOHOL | 50.00 | 48.00 | 46.00 | 60.00 | 65.00 | 44.00 | 68.00 |

| | | | | | | | |
|---|---|---|---|---|---|---|---|
| TOTAL SOLID CONTENT (%) | 21 | 21 | 21 | 18 | 17 | 22 | 16 |

| | | | | | | | | | |
|---|---|---|---|---|---|---|---|---|---|
| CHARAC- | MEMBRANE | GLOSSINESS | ⊚ | ⊚ | ⊚ | ⊚ | ⊚ | ⊚ | ⊚ |
| TERISTIC | CHARAC- | (SPECULAR | | | | | | | |
| EVALUATION | TERISTICS | GLOSSINESS AT 60°) | | | | | | | |
| | | REFLECTANCE | ⊚ | ⊚ | ⊚ | ⊚ | ⊚ | ⊚ | ⊚ |
| | | (550 nm REFLECTANCE) | | | | | | | |
| | | L VALUE | ◯ | ◯ | ◯ | ⊚ | ⊚ | ⊚ | ◯ |
| | | (L* VALUE IN CIELAB | | | | | | | |
| | | COLOR SPACE SYSTEM) | | | | | | | |
| | | LIGHT-SHIELDING | X | X | ◯ | ◯ | ◯ | ⊚ | ⊚ |
| | | CHARACTERISTIC | | | | | | | |
| | | ADHESIVENESS | X | X | X | ◯ | ◯ | ◯ | ◯ |
| | | ※COMPREHENSIVE | X | X | X | ◯ | ◯ | ⊚ | ◯ |
| | | EVALUATION | | | | | | | |
| | | HAZE | 1.7 | 5.0 | | | | 8.5 | |

### 4. Consideration

As shown in Table 1, in the case where one or more of (A1) and (A2) was not included as (A) in a composition contained in a paint (Examples 1 to 3), one or more of glossiness, reflectance, an L value and adhesiveness, which are membrane characteristics, was not satisfied. On the other hand, even if both of (A1) and (A2) were included as (A) in a composition (Examples 4 to 10), when a mass ratio of a resin solid content of (A2) with respect to a resin solid content of (A1): 1 was less than 1.8 (Example 4) or exceeds 4.4 (Example 10), adhesiveness in the membrane characteristics was not satisfied. While, even if both of (A1) and (A2) were included and a range of a mass ratio of a resin solid content of (A2) with respect to a resin solid content of (A1): 1 was proper (1.8 or more and 4.4 or less) (Examples 6 and 11 to 17), (B1) having a particle diameter in a predetermined range is not included in (B) (Examples 11 to 13) or, even if (B1) having a particle diameter in a predetermined range is included in (B), when a mass ratio of (B) with respect to a resin solid content of (A1): 1 was less than 1.3 (Example 14) or exceeded 4.0 (Example 17), one or more of the membrane characteristics, which are glossiness, reflectance, an L value and adhesiveness, was not satisfied.

On the other hand, when a range of a mass ratio of a resin solid content of (A2) with respect to a resin solid content of (A1): 1 was proper (1.8 or more and 4.4 or less) (Examples 5 to 9, 15 and 16), all of the paint characteristics and the membrane characteristics were satisfied.

As shown in Table 2, even if both of (A1) and (A2) were included as (A) in a composition contained in a paint (Examples 4a to 10a), when a mass ratio of a resin solid content of (A2) with respect to a resin solid content of (A1): 1 was less than 1.8 (Example 4a) or exceeded 4.4 (Example 10a), adhesiveness in the membrane characteristics was not satisfied. Even if both of (A1) and (A2) were included and a range of a mass ratio of a resin solid content of (A2) with respect to a resin solid content of (A1): 1 was proper (1.8 or more and 4.4 or less) (Examples 6a and 11a to 17a), when (B1) having a particle diameter in a predetermined range was not included in (B) (Examples 11a to 13a) or, even if (B1) having a particle diameter in a predetermined range was included in (B), when a mass ratio of (B) with respect to a resin solid content of (A1): 1 was less than 1.3 (Example 14a) or exceeded 4.0 (Example 17a), one or more of the membrane characteristics of glossiness, reflectance, an L value and adhesiveness was not satisfied.

On the other hand, when a range of a mass ratio of a resin solid content of (A2) with respect to a resin solid content of (A1): 1 was proper (1.8 or more and 4.4 or less) and a mass ratio of (B) with respect to a resin solid content of (A1): 1 was proper (1.3 or more and 4.0 or less) (Examples 5a to 9a, 15a and 16a), it was possible to satisfy all of the paint characteristics and membrane characteristics.

As shown in Table 3, when fixing an amount of (B) and an amount of (A) and changing a ratio of (A1) and (A2) in (A) (Examples 6 and 18 to 23), it was confirmed that, as a ratio of a resin solid content of (A2) with respect to a resin solid content of (A1) increases, an L value and, although it is not essential, a light-shielding characteristic were improved while maintaining good performance of glossiness and reflectance in the membrane characteristics. Note that a haze value in Table 3 is a haze value of a membrane (thickness 12 μm) obtained by forming with a mixture of (Ala) and (A2a) in a mass ratio (in terms of a resin content) shown in Table 3 (note that (B) is not included) and is a value measured by using a hazemeter (NDH4000, by NIPPON DENSHOKU Industries Co., Ltd.) in the method based on JIS K7136 in the same way as above.

### Example 24

Other than using black acrylic beads having a little large particle diameter (a particle diameter of 5 to 6 μm), which was a spheric acrylic resin particle containing CB as same as in B1a, instead of B1a, a water-based paint having an identical composition with that in Example 6 was prepared. Then, membranes 1 and 2 were formed in the same way as above and the same evaluations were made. It was confirmed that the same evaluation results as those on Example 6 was obtained.

1. A water-based resin composition for a paint, comprising at least (A) and (B): wherein
(A) comprises a water dispersion resin mixture obtained by combining a plurality of water dispersion resins incompatible to one another;
(B) comprises 90% by mass or more of (B1) having a particle diameter of 2 μm or more and 6 μm or less, and a mass ratio of (B) with respect to a resin solid content of (A): 1 is 1.3 or more and 4.0 or less;
(A) is a resin component;
(B) is a black material; and
(B1) is a composite of a black pigment and a resin.

2. A water-based resin composition for a paint according to claim 1,
(A) comprises (A1) and (A2) in an amount of 90% by mass, and a resin solid content of (A2) with respect to a resin solid content of (A1): 1 is 1.8 or more and 4.4 or less;
(A) is a resin component;
(A1) is an acrylic resin emulsion;
(A2) is a polyester-based resin emulsion.

3. The composition according to claim 1, wherein (B1) comprises an acrylic resin particle containing carbon black.

4. The composition according to claim 2, wherein (A) furthermore comprises (A3), and a mass ratio of (A3) with respect to a resin solid content of (A1): 1 is 1.2 or more and 1.7 or less; and
(A3) is a water-soluble polymer.

5. A paint comprising a composition according to claim 1, and (C): wherein viscosity at 25° C. measured by a B-type viscometer is 1 mPa·s or more and 300 mPa·s or less; and
(C) is a diluting solvent.

6. The paint according to claim 5, used for applying to model parts.

7. The paint according to claim 5, used for applying to camera parts.

8. The paint according to claim 5, used for applying in a spray coating method, wherein viscosity at 25° C. measured by a B-type viscometer is 1 mPa·s or more and 50 mPa·s or less.

9. A pen-type application tool, filled therein with a paint according to claim 5 having viscosity of 1 mPa·s or more and 300 mPa·s or less at 25° C. measured by a B-type viscometer.

10. A membrane formed from a paint according to claim 5, wherein an outermost surface of a plane formed with the membrane has glossiness of less than 1.0% against an incident light at an angle of 60°, reflectance of less than 1.5% against a light having a wavelength of 550 nm, and an L value of less than 15 in the CIELAB color space system by the SCE method.

11. The membrane according to claim 10, wherein an outermost surface of a plane formed with the membrane has an optical density of 2.0 or more in the case where a light-shielding characteristic when transmitting a light is required to the membrane.

12. The composition according to claim 2, wherein (B1) comprises an acrylic resin particle containing carbon black.

13. The composition according to claim 12, wherein (A) furthermore comprises (A3), and a mass ratio of (A3) with respect to a resin solid content of (A1): 1 is 1.2 or more and 1.7 or less; and
(A3) is a water-soluble polymer.
